(19) United States
(12) Patent Application Publication
(10) Pub. No.: US 2006/0116105 A1
(43) Pub. Date: Jun. 1, 2006

(54) Multiple identities for communications service subscriber with real-time rating and control

(75) Inventors: Bruce Frankel, Marlton, NJ (US); Paresh Shah, Moorestown, NJ (US); Chris Giacoponello, Pottstown, PA (US); Figen Ceceli, Marlton, NJ (US); Wesley Porter, Medford, NJ (US)

Correspondence Address: STAAS & HALSEY LLP, SUITE 700, 1201 NEW YORK AVENUE, N.W., WASHINGTON, DC, 20005, US

(73) Assignee: COMVERSE, Inc., Wakefield, MA (US)

(21) Appl. No.: 10/998,564

(22) Filed: Nov. 30, 2004

(51) Int. Cl. H04Q 7/20

(52) U.S. Cl. 455/406

(57) ABSTRACT

Multiple Identity empowers a subscriber to use several accounts to charge and control their subscribed services. The subscriber can segment their activities into different accounts to meet their different life roles. This specifying and directing of activities, both incoming and outgoing, may be automatically or manually segmented. Rules are defined for selecting the preferred identity automatically in real-time, based on any of date/time, location of the subscriber, and the service requested; including specific phone numbers (or other communication terminal identifiers) connected to a communication device, such as a cellular telephone. The subscriber is also provided with a mechanism for manually specifying the identity to be used for a particular communication session.

### BACKGROUND OF THE INVENTION

1. Field of the Invention

The present invention is directed to billing for communications services and, more particularly, to selecting an account to be charged.

2. Description of the Related Art

Many forms of communications are made possible for subscribers using terminals that are either mobile or fixed in location. The communications may be of any type, including such forms as audio, such as telephone or radio; text, e.g. short message service (SMS); Multimedia Message Service (MMS); graphics, such as those provided by the World Wide Web; or a video, and others. The different forms of communications may be transmitted to and from a single terminal by a single provider, or by multiple providers in cooperation with one another, or less often, independently. However, conventionally a communications services provider uses a single identifier to communicate with a terminal. In the case of land line terminals, the terminal (telephone, facsimile machine, etc.) is identified by a port on a switch. In the case of a computer connected to the Internet, the computer terminal is identified by an Internet Protocol (IP) address.

Different terms are used for the identifier of a mobile telephone, depending upon how it communicates. For Global System for Mobile (GSM) communications, an International Mobile Equipment Identity (IMEI) is stored in the handset, while the MSISDN (Mobile Subscriber Integrated Services Digital Network Number) and the IMSI (International Mobile Subscriber Identifier) are stored in the Subscriber Identity Module (SIM). In the case of a Code Division Multiple Access (CDMA) mobile telephone, a Mobile Identification Number (MIN) and the IMSI are stored in the Number Assignment Module (NAM). The NAM is part of the User Identity Module/Removable User Identity Module (UIM/R-UIM). In the case of IP communications, the MAC address is stored in the equipment and is equivalent to the IMEI/ESN, while the IP address is equivalent to the MSISDN/MIN.

Some mobile telephones or other terminals have more than one identification storage unit (e.g., SIM and/or NAM), or one or more sockets, so that the SIM, NAM, etc., is removable. For example, cellular telephones are currently available that are capable of communication in more than one type of system and have both a SIM and a NAM. In some of these terminals, users are able to replace the SIM/NAM to manually change the identity supplied by the terminal. In these terminals, each SIM/NAM is provisioned separately, typically by customer service personnel of the service provider.

The identifier stored in the SIM, NAM, etc. is used not only to establish connections, but also to determine the cost of a communication session. In the case of mobile telephones, known methods of billing include “post-pay,” where the cost is determined after the end of the communication session and the subscriber receives a bill for payment on a regular basis, e.g., monthly. Other billing methods include “pre-pay” and real-time billing (RTB) which both determine cost during the communication session and terminate the session if the available funds that have been pre-paid are exhausted, or pre-defined limits of a post-pay system are reached, respectively. Another method known by the inventors is a “toggle” system which permits a single subscriber identifier to be switched between pre-pay and post-pay.

Variations on these basic billing methods are known from U.S. Pat. Nos. 6,026,291 and 6,256,504 and U.S. Patent Application Publications 2003/0032404 and 2003/0115138. The '291 patent discloses a post-pay cellular system having programmable subscription capability. The system uses the home location register (HLR), which is accessed when a call to or from a cellular telephone is initiated, to provide instructions to a Mobile Switching Center (MSC) regarding which attributes to record in a Call Detail Record (CDR) used in determining the cost of a communication session. The instructions are based on profiles stored in the HLR. The profiles are defined by subscription, user and terminal records. Subscription records contain information regarding agreements between users and cellular system operators on the usage of telecommunications services within a telecommunications network. User records contain information regarding persons who have access to the telecommunications services within a cellular system. Terminal records contain information regarding particular cellular subscriber stations or terminals. Thus, a single user may have multiple subscriptions or multiple terminals, or both. When a communication session is initiated with a terminal, a base station controller (BSC) provides a communication link with the cellular telephone terminal and sends the MIN to the home MSC of the terminal. Relationships between the subscription, user and terminal records are maintained as lists of user subscriptions for a user and allowed users for subscriptions. The user subscriptions list defines who will be charged for a call based on a schedule of day and time. If permitted by the profile, a user may send a feature request signal to select a different subscription.

The '504 patent discloses a billing system for mobile telephone users based on location of the mobile unit. The HLR executes a location sensitive billing (LSB) application in addition to a conventional HLR application. Location finding equipment (LFE) may be provided on the network side or in the mobile subscriber unit. During operation, a location function controller (LFC) in the HLR stores location information in a location cache (LC) that is accessed by the LSB application to generate a bill for the subscriber. A user may define zones such as “home”, “office” and “cellular” by informing the service provider of the geographical areas for the first two which can be charged at a lower rate than the cellular zone which is everywhere outside the home and office zones. Each time the subscriber initiates a call, the system informs the subscriber via an audio or text message of the current zone of operation and the subscriber is given an opportunity to terminate the call prior to being charged.

The '404 publication is directed to provisioning service zones for location sensitive billing. Geographical map data is utilized by a user interface to enable selection of zones as defined in a service subscriber database.

The '138 publication discloses a billing system for use of a telephony device after identifying the user of the device, so that the user's account can be charged, regardless of who is registered as owning the device. Caller identity authentication may be performed by the originating device, the destination device, or an intermediary device processing the call. Authentication methods mentioned include voice authentication; biophysical identifiers, such as an eye scan or a fingerprint; keypad entries, such as a PIN code, account number, password, etc.; and other secure transaction keys. Once the user has been identified, the billing information ordinarily used for a call placed from the device is replaced with the billing plan for the identified user in a service control point (SCP) or other billing system storage.

Although it is known to use a HLR to store profiles of users in which there may be multiple relationships between users, subscriptions and terminals, there is no known way of selecting a user identity or subscription plan for charging an account based on activities performed by the user. That requires intelligence in the device processing the communication, such as a signal control point in an intelligent network (IN).

### SUMMARY OF THE INVENTION

An aspect of the present invention is to provide for real-time authorization and billing different accounts associated with a subscriber's terminal without modification of the terminal. This includes supporting simultaneous activities to multiple different accounts.

Another aspect of the present invention is to enable multiple users to share a single terminal with each user having a separate account.

A further aspect of the present invention is to enable a single terminal to be used for different activities with charges to an appropriate account for each activity, such as charging a personal account for playing games on a cellular telephone that is used primarily for business.

Yet another aspect of the present invention is to enable a single user with a single terminal to distribute their communications costs, across multiple financial domains.

The above aspects can be attained by a method of providing services for a subscriber using a communication terminal, including storing subscriber identity rules based on at least activities of a subscriber; and selecting, in accordance with the subscriber identity rules, one of a plurality of accounts associated with the subscriber to record a cost of at least one of a communication session and a commerce transaction. In particular, the account may be selected when the communication is initiated using a terminal of the subscriber.

The invention is particularly useful in conjunction with mobile communication terminals. When the communication terminal is mobile, the subscriber identity rules preferably include at least one of date, time, and location of the communication terminal, and the selecting may be based on an activity in which the communication terminal is used and at least one of date, time, and location of the communication terminal during the communication session.

In addition, the accounts may be associated with at least one mobile communication terminal of the subscriber different from the communication terminal used in providing the services which may be a landline telephone, for example. Then, the method preferably includes receiving from the communication terminal an identifier associated with the at least one mobile communication terminal of the subscriber to identify the one of the accounts that is selected. The form of the identifier may be any that is currently known or developed in the future.

The accounts may include at least one group account of which the subscriber is a member. Particularly in the case of a group account, such as a business account, the subscriber identity rules may restrict at least one activity. Due to such restrictions or insufficient funds in an initially selected account, a different account permitting the at least one activity may be selected either automatically or in response to a signal from the communication terminal.

These aspects can also be attained by a system for providing services for a subscriber using a communication terminal, including at least one storage device storing subscriber identity rules based on at least one of date, time, activity, and location; and at least one real time activity control device selecting, in accordance with the subscriber identity rules, one of a plurality of accounts associated with the subscriber to record a cost of at least one of a communication session and a commerce transaction.

Preferably, the system includes at least one interface to receive signals generated when the communication is initiated using the communication terminal of the subscriber. The interface may include a gateway to receive one of unstructured supplementary service data, a feature request and short message service text, indicating a change in identity requested by the subscriber for subsequent communications. The interface may also include at least one of a Web server, a handheld application server and an intelligent peripheral/interactive voice response (IP/IVR) server. The Web server may be used when the communication terminal is a data terminal capable of communicating via the World Wide Web and the IP/IVR server may be used when the communication terminal is a landline or mobile telephone.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a block diagram of a relationship between a subscriber and identities according to an aspect of the invention.

FIG. 2 is a block diagram of a communications system illustrating mechanisms for establishing identities for a subscriber according to an aspect of the invention.

FIG. 3 is a block diagram of a communications system with an identity manager according to an aspect of the invention.

FIG. 4 is an example of a Web interface for manually changing identity.

FIG. 5 is a flowchart for an overview of selecting an account to determine permitted activities according to an aspect of the invention.

FIG. 6 is a more detailed flowchart of determining an identity, i.e., selecting an account to determine permitted activities according to an aspect of the invention.

FIG. 7 is an example of entries in an identity database for one subscriber that could be used by the method illustrated in FIG. 6.

FIG. 8 is an example of a log file recording the history of changes in identity.

### DETAILED DESCRIPTION OF THE PREFERRED EMBODIMENTS

Following are several terms or acronyms used herein that are commonly used reference to communication networks, particularly telecommunications that include mobile or cellular or terminal devices, such as cellular telephones.

CDMA Code Division Multiple Access

COS Class of service

CRM Customer Relationship Management

ESN Electronic Serial Number

FeatReq Used to transmit information via signaling channels of a CDMA network

GGSN Gateway GPRS Support Node

GPRS General Packet Radio Service

GSM Global System for Mobile Communication

HHAP Hand Held Application Server

HLR Home Location Register

IMEI International Mobile Equipment Identity

IMSI International Mobile Subscriber Identifier

IN Intelligent Network

IP Internet Protocol

IVR Interactive Voice Response

MIN Mobile Identification Number

MMS MultiMedia Messaging Service

MSC Mobile Switching Center

MSID Mobile Station ID

MSISDN Mobile Subscriber Integrated Services Digital Network Number

NAM Number Assignment Module

RTBS Real-Time Billing System

SCP Service Control Point (Processor)

SGSN Serving GPRS Support Node

SIM Subscriber Identity Module

SMS Short Message Service

SMSC Short Message Service Center

Terminal User communications device, such as a cellular telephone

UIM/R-UIM User Identity Module/Removable-User Identity Module

USSD Unstructured Supplementary Service Data (available in GSM networks)

WWW World Wide Web

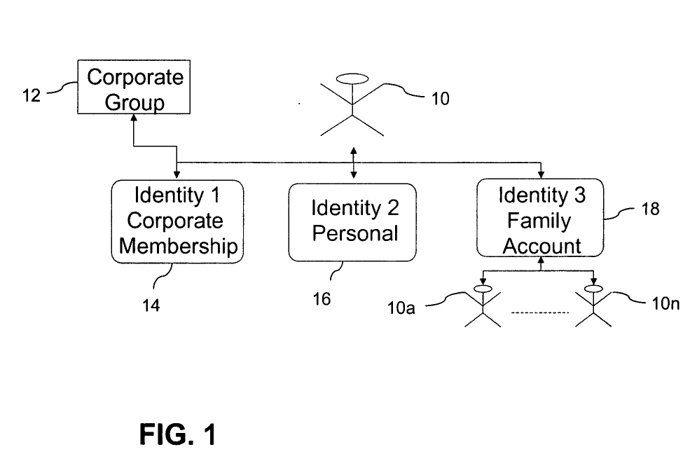

As illustrated in FIG. 1, according to the present invention, a subscriber 10 may have multiple identities, each of which corresponds to an account within a communications system from a service provider. When, as illustrated in FIG. 1, subscriber 10 is a member of corporate group 12, one of the identities may be corporate membership 14. In addition, subscriber 10 may have personal identity 16 and be a member of family account 18. Each of the identities has associated therewith a type and a name, as well as parameters, some of which are common for a single subscriber and other of which are unique, such as those defining the class of service (COS).

Common parameters for a single subscriber and a single communication device will typically be the identifiers of the equipment and subscriber, in particular, ESN or IMEI, MSISDN or MIN, and IMSI. Unique parameters for each identity or account of the subscriber may include (a) treatments, such as life-cycle, notifications, announcements, etc.; (b) permissible activities, such as local voice, SMS, MMS, gaming, etc.; (c) subscribed features, such as friends & family, group account, call forwarding, voice mail, etc.; (d) promotions, such as discounts, bonus, awards, etc.; and (e) charges, including tariffs, periodic and usage.

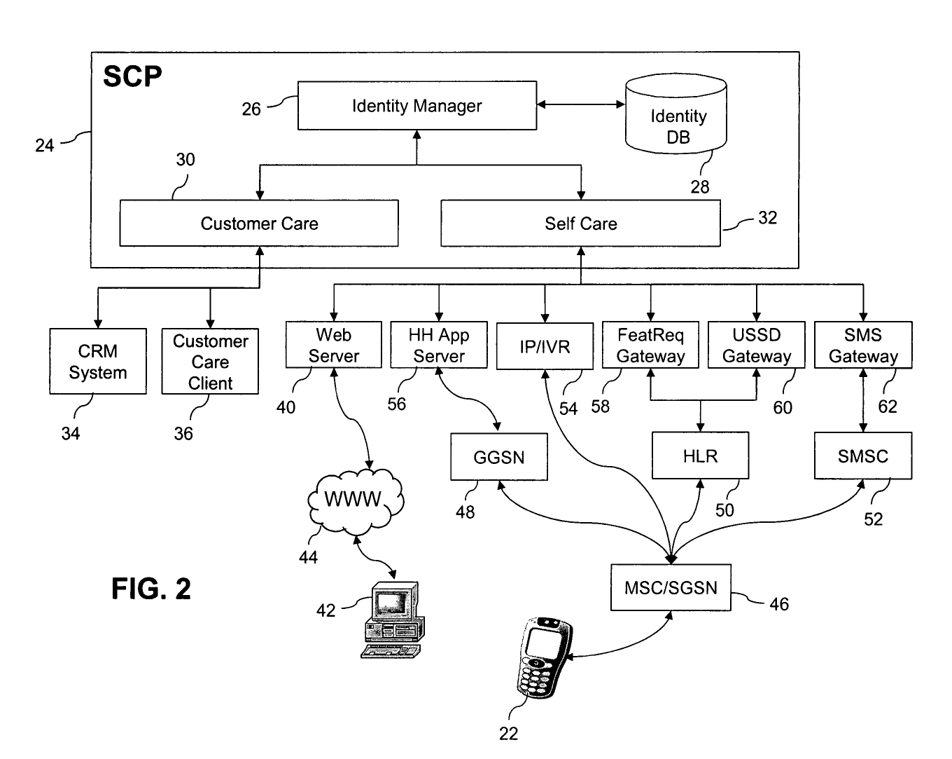

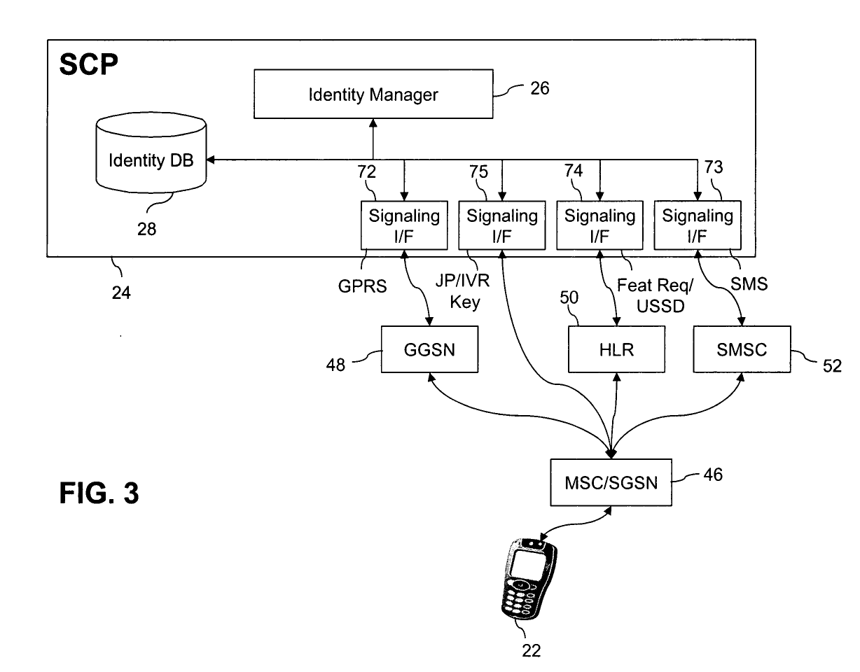

An exemplary embodiment of a communication system according to one aspect of the present invention for use with cellular telephone 22 is illustrated in FIGS. 2 and 3. According to an aspect of the present invention, service control point 24 includes identity manager 26 and information about subscriber identities represented by identity database 28, in addition to programs and data to provide and control conventional services. The information in identity database 28 includes subscriber identity rules based on at least one of date, time, activity and location, as described further below. This information may be entered using customer care portal 30 or self care portal 32. Customer care portal 30 may be accessed by customer care representatives using customer relationship management system 34 or customer care client 36 to provision identity database 28 and assign identities to subscribers and subsequently to change a current identity of a subscriber, in addition to the typical customer care functions of account provisioning, answering account questions etc.

Following is a list of the types of operations that subscribers might be able to have performed on the data in identity database 28 either a customer care representative, or using one of the self-care options discussed below:
(1) Obtain help about using the different identities
(2) Inquire about the current identity
(3) Change the current identity
(4) Obtain a listing of all currently defined identities
(5) Modify the identity name associated with each identity type, i.e. ID type 1=“Bob”, ID type 2=“Comverse”, ID type 3=“The Smiths”
(6) Obtain account information such as balances, expiration dates, state, transactions, etc. for any given identity of the subscriber
(7) Delete a currently defined identity (except the current identity)
(8) Add a new identity and select the service characteristics for it
(9) Move charges inadvertently made by one identity to another identity and adjust the charges appropriately

There are many ways a subscriber could directly interact with identity manager 26, some of which would only be available in particular types of communications systems. In addition to using a communications terminal, such as a cellular telephone 22, Web server 40 could be accessed by any user device 42 capable of communicating therewith via the World Wide Web 44. In existing cellular telephone networks, signals from cellular telephone 22 pass through mobile switching center or serving general packet radio service support node (MSC/SGSN) 46 which communicates with gateway GPRS support node 48, home location register (HLR) 50 or short message service center (SMSC) 52, depending upon the type of network and mode of communication. In addition, terminal 22 could be used to communicate with IP/IVR system 54 which can interact directly with terminal 22 via an Internet Protocol, interactive voice response, or a keypad interface. Alternatively, server 56 running handheld applications could be used to communicate between terminal 22 and self care application 32.

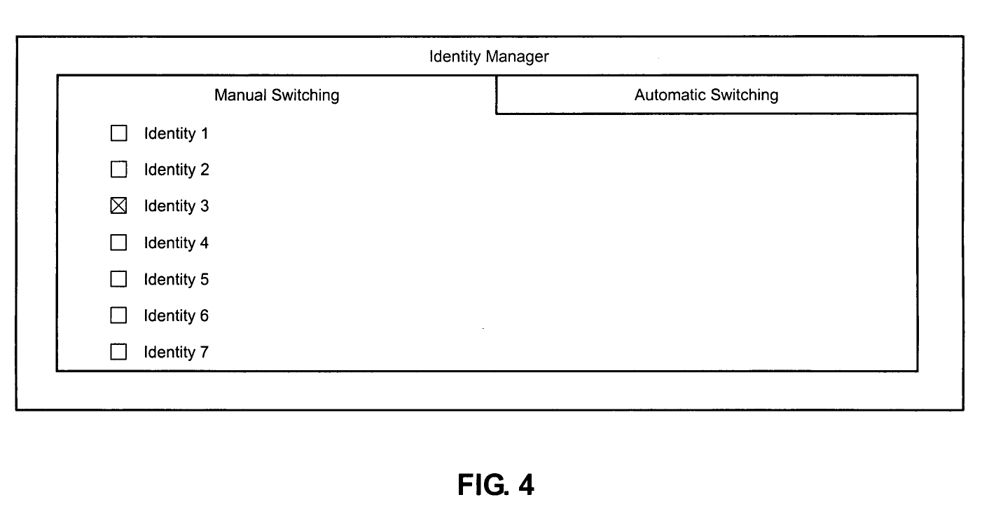

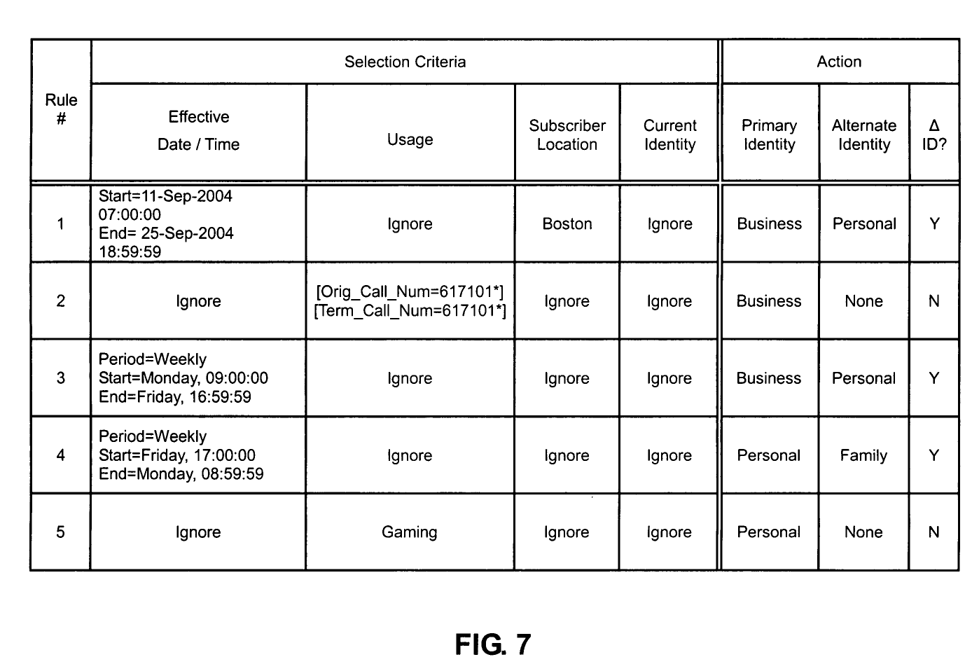

An example of a the type of screen display that might be generated for manually changing identity via Web server 40 is illustrated in FIG. 4. The subscriber would navigate the World Wide Web using any conventional browser to reach the page illustrated in FIG. 4. The checkboxes on the left are termed “radio buttons” and only one can be checked at a time. The subscriber would select the identity to be used for the next activity, such as a series of phone calls. A page similar to that illustrated in FIG. 7 might be displayed to permit the subscriber to change rules if the subscriber has the authority to make changes. Web server 40 may enable the end user to change the rules of an identity, e.g., which activities are permitted, what discount plans are available for choosing, etc. Additionally, the end user may also inquire about each identity status and balances. Balance transfer between identities may also be possible using Web server 40.

Currently, most cellular telephone networks in the United States are either code division multiple access (CDMA) or global system for mobile (GSM) communications networks. Each of these types of networks are able to send signaling data through HLR 50. CDMA networks provide such signaling via what are termed feature requests (FeatReqs) and such signals would be processed by FeatReq gateway 58. In GSM networks, unstructured supplementary service data (USSD) can be transmitted using HLR 50. USSD gateway 60 may be provided to supply information related to subscriber identities to self care application 32. Some networks of both CDMA and GSM provide short message service (SMS) via SMSC 52. SMS gateway 62 may be provided to supply identity information to self care application 32.

FeatReq gateway 58 and USSD gateway 60 would receive codes transmitted via CDMA and GSM networks, respectively, identifying specific operations to be performed. An example of the codes and corresponding operations that could be implement is provided in the table below.

| | Identity | | |
|---|---|---|---|
| Access | Switching | | |
| Code | Action | Operation | Notification |
| *440 | Identity Help | Display a text string | End of |
| | | | transmission |
| *441 | Identity 1 | current identity [symbol] Identity 1 | ID changed to |
| | | | <Identity Tag> |
| *442 | Identity 2 | current identity [symbol] Identity 2 | ID changed to |
| | | | <Identity Tag> |
| *443 | Identity 3 | current identity [symbol] Identity 3 | ID changed to |
| | | | <Identity Tag> |
| *444 | Identity 4 | current identity [symbol] Identity 4 | ID changed to |
| | | | <Identity Tag> |
| *445 | Identity 5 | current identity [symbol] Identity 5 | ID changed to |
| | | | <Identity Tag> |
| *446 | Identity 6 | current identity [symbol] Identity 6 | ID changed to |
| | | | <Identity Tag> |
| *447 | Identity 7 | current identity [symbol] Identity 7 | ID changed to |
| | | | <Identity Tag> |
| *448 | Next | current identity [symbol] next | ID changed to |
| | Identity | available identity | <Identity Tag> |
| *449 | Previous | current identity [symbol] previous | ID changed to |
| | Identity | defined identity | <Identity Tag> |
| *450 | Current | Display current identity | Current identity |
| | Identity | | is <Identity Tag> |

Any conventional IP/IVR system could be used as IP/IVR system 54. IP/IVR system 54 allows the end users to do all of the activities offered by Web server 40 using a menu driven voice response system. The IVR system would generate a series of prompts offering the subscriber to initiate operations similar to those described above for the other interfaces and the subscriber would indicate responses either orally or by pressing on a phone keypad. IP/IVR system 54 collects each response and offers more prompts based on the response to receive further information to perform the desired operation. In short, the subscriber can select the identity, check the status of the identity, check the balances associated with the identity, select discount plans, add/remove service and feature offerings, add/modify/delete numbers to/from a friends and family list associated with the identity, and transfer funds between identities, among other things offered by a service provider.

The subscriber identity rules stored in identity database 28 define a relationship between a subscriber identity and an account. As illustrated in FIG. 1, there may be a one-to-one relationship, as in the case of personal account 16, or the subscriber identity may be associated with an account used by others, such as corporate membership 14 or family account 18. What is defined by the subscriber identity rules may include date/time periods during which an identity applies for subscriber 10 or communication terminal 22 and which account to use if communications terminal 22 is in one or more predefined areas. The date/time and location defaults may be separate or combined. For example, if terminal 22 is in a location where business calls are ordinarily made during a time when the subscriber is normally working, corporate account 14 would be the account selected for use, or the subscriber identity rules could select corporate account 14 for any call during “business hours” or when terminal 22 is in a business location at any time.

In addition, the subscriber identity rules preferably include the ability to define restrictions or permissions for activities. Examples of activities that could be expressly restricted or permitted include voice calls (local, long distance, international, calls to/from explicit destinations) e-commerce and m-commerce purchases, file downloads, video/audio streams, mobile enterprise applications, gaming, etc

An example of a communications system according to an aspect of the present invention during operation is illustrated in FIG. 3. SCP 24 is provided with signaling interfaces 72-75 for processing signals transmitted via GPRS, SMS, FeatReq/USSD, or an alternative interface (IP, IVR, keypad, etc.), respectively. Any of these signaling technologies may be used to override the default subscriber identity rules, if the rules are set up to permit such overrides. For example, if a cellular telephone, used as terminal 22, is provided by an employer, it may be desirable to provide the employer with the option of restricting overrides to execute any game application during business hours.

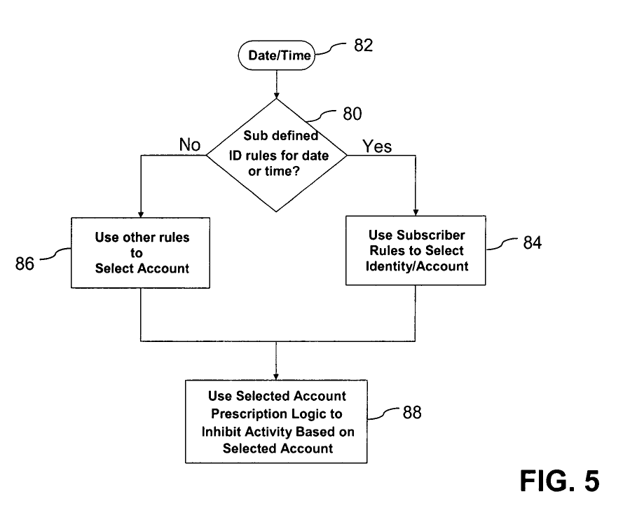

An overview of how such restrictions could be implemented is provided in the flowchart illustrated in FIG. 5. The subscriber identity rules are checked 80 to determine whether any rules are based on date/time 82. If so, the subscriber identity rules are used 84 to select the identity/account that applies at this point in time; if not, other rules are used 86 to select the account. Prescription logic in the selected account is then applied 88 to inhibit unacceptable activities, such as interactive gaming. Since SCP 24 controls the services provided to terminal 22, it is easy to restrict activities using the subscriber profile in the charging system. These restrictions may be expressed in white and black lists, lack of a defined activity in the profile, lack of a defined feature in the profile, the lack of a defined tariff for an activity, or the lack of funding sources in the account.

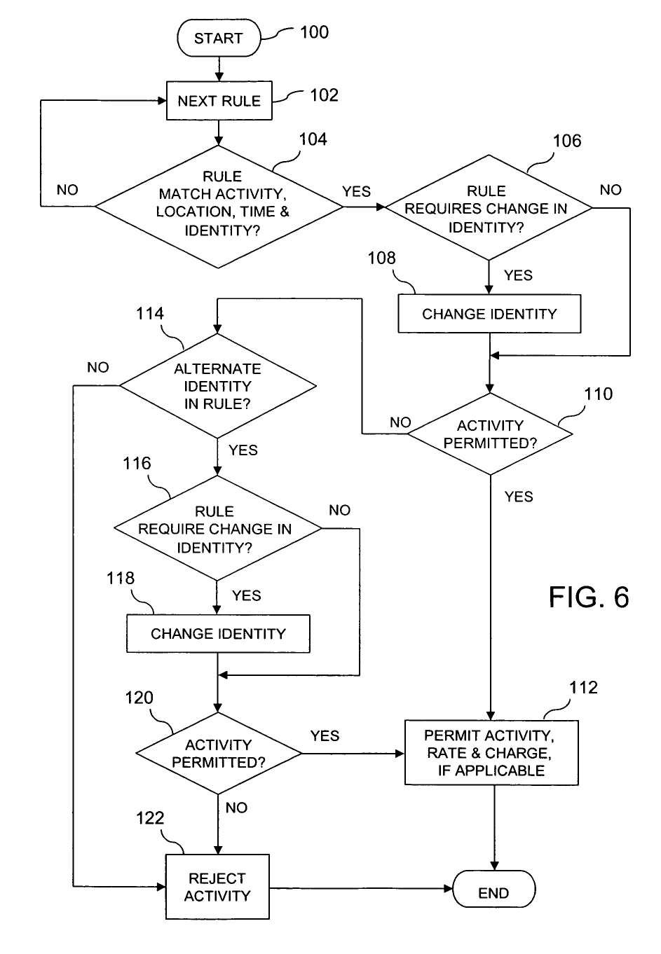

A more detailed flowchart of the method for determining an identity of a subscriber is illustrated in FIG. 6 which will be described with reference to the sample database entries illustrated in FIG. 7. At the start 100, the rule number is initiated so that the next rule 102 to be considered is Rule Number 1 in the entries for the subscriber in identity database 28 (FIG. 2). If the rule matches 104 the activity, location, date/time and current identity of the subscriber, the rule will be applied. In the exemplary database entries in FIG. 7, if it is between September 11, and Sep. 25, 2004 during the hours of 07:00 and 19:00 and the subscriber is in Boston, then the first rule matches 104. As indicated by the “Y” in the last column of FIG. 7, this rule requires 106 a change in identity. Therefore, the current identity of the subscriber will be changed 108 to “Business.” Next, it is determined 110 whether the “Business” identity of the subscriber permits the activity that the subscriber has initiated. For example, the “Business” identity of this subscriber might permit international long distance (as well as any other voice calls), a virtual private network (VPN) and short message service (SMS). If the subscriber is initiating one of these activities, the activity will be permitted 112.

If it is determined 110 that the subscriber is attempting an activity that is not permitted by the identity, such as playing interactive games, then it is determined 114 whether there is an alternate identity for this rule. In the case of Rule Number 1 in FIG. 7, there is an alternate identity of “Personal” which might permit the activity. Once again, it is determined 116 whether the rule requires the identity to be changed and, if so, the identity is changed 118. Regardless of whether the identity is changed, it is determined 120 whether the activity is permitted. For example, the subscriber may not have signed up for the service being requested, or may not have enough money in a pre-paid account to pay for the requested service.

If the criteria for application of the first rule are not matched 104, the next rule is selected 102 for consideration. In the example illustrated in FIG. 7, if the date/time do not match 104 the requirements for Rule Number 1, but the subscriber is calling from or to a telephone number that begins with area code 617 and exchange 101, then the subscriber's “Business” account may be charged, but without changing 108 his or her identity for subsequent activities. If the subscriber attempts to engage in an activity not permitted 110 by the “Business” identity, it will be determined 114 that there is no alternate identity in Rule Number 2 and the activity will be rejected 122.

If no match 104 is found for the selection criteria in the first two rules, the remaining rules are considered in sequence. In the example illustrated in FIG. 7, Rule Number 3 applies from Monday at 9 a.m. to Friday at 5 p.m. to identify the subscriber using his or her “Business” identity, unless the activity is not permitted 110, in which case the subscriber's “Personal” identity may be used. Rule Number 4 applies on weekends to identify the subscriber using the “Personal” identity with an alternate identity of “Family.” The “Family” identity might permit an additional activity, such as long distance calls, or be provided as a backup if there is a problem with the subscriber's “Personal” account. In the example illustrated in FIG. 7, Rule Number 5 charges all gaming to the subscriber's “Personal” account without changing the current identity of the subscriber for subsequent activities.

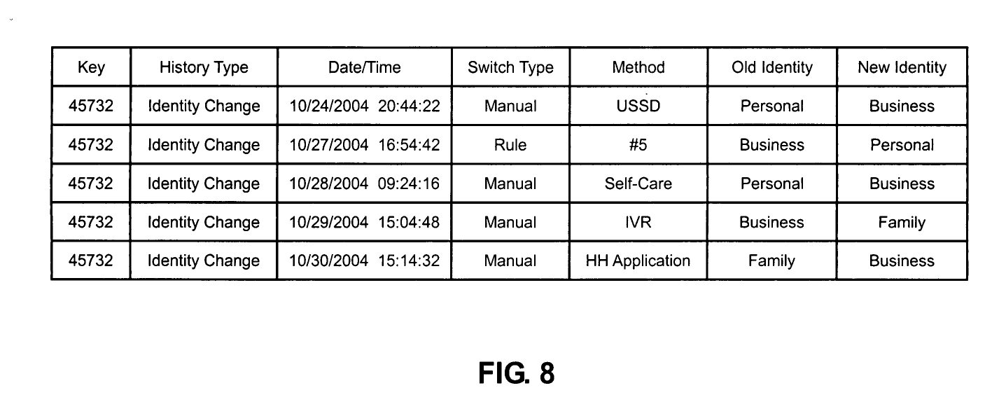

A history of the changes in identity is preferably maintained in a log file. Each time a subscriber's identity is switched, a history record is recorded and stored in association with the subscriber's detail record. This history record can be used to inform the subscriber about all identity switches and may be referenced by customer care personnel when researching billing problems. An example of a portion of such a log file containing only identity changes for a single subscriber is provided in FIG. 8. The first column, “Key” is a subscriber identifying number, such as an MSISDN, MIN, etc. The second and third columns indicate the type and time of the activity. The fourth and fifth columns indicate the type and method used to perform the change or switch in identity, while the last two columns indicate what change occurred.

The present invention has been described primarily with respect to use of a cellular telephone as a communication terminal. However, the invention is not limited to this particular type of terminal and can be employed in other communications networks. The invention can be used in any system where a user is charged for usage and is identified by the system using an identification value such as an MSISDN, an IP address, a directory number, an account number, or any other identifying attribute.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention as recited in the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

What is claimed is:

1. A method of providing services for a subscriber using a communication terminal, comprising:
storing subscriber identity rules based on at least activities of a subscriber; and
selecting, in accordance with the subscriber identity rules, one of a plurality of accounts associated with the subscriber to in real-time, authorize, calculate, and record a cost of at least one of a communication session and a commerce transaction.

2. A method as recited in claim 1, wherein said selecting is performed when the communication is initiated using a terminal of the subscriber.

3. A method as recited in claim 2,
wherein the communication terminal is mobile and the subscriber identity rules further include at least one of date, time, and location of the communication terminal, and
wherein said selecting is further based on an activity in which the communication terminal is used and at least one of date, time, and location of the communication terminal during the communication session.

4. A method as recited in claim 2, wherein the accounts include at least one group account of which the subscriber is a member.

5. A method as recited in claim 4, wherein the subscriber identity rules restrict at least one activity.

6. A method as recited in claim 5,
wherein the communication terminal is mobile and the subscriber identity rules further include at least one of date, time, and location of the communication terminal, and
wherein said selecting is further based on an activity in which the communication terminal is used and at least one of date, time, and location of the communication terminal during the communication session.

7. A method as recited in claim 6, further comprising selecting a different account permitting the at least one activity, either automatically or in response to a signal from the communication terminal.

8. A method as recited in claim 4, further comprising automatically selecting a different account permitting the at least one activity when the communication terminal is used in the at least one activity.

9. A method as recited in claim 2, further comprising selecting a different account in response to a signal from the communication terminal.

10. A method as recited in claim 2, further comprising automatically selecting a different account when the communication terminal is used in an activity not permitted by the one of the accounts selected initially.

11. A method as recited in claim 1, further comprising selecting a different account in response to a signal from the communication terminal.

12. A method as recited in claim 1, further comprising automatically selecting a different account when the communication terminal is used in an activity not permitted by the one of the accounts selected initially.

13. A method as recited in claim 1,
wherein the communication terminal is mobile and the subscriber identity rules further include at least one of date, time, and location of the communication terminal, and
wherein said selecting is further based on an activity in which the communication terminal is used and at least one of date, time, and location of the communication terminal during the communication session.

14. A method as recited in claim 1, wherein the communication terminal is a mobile communication terminal used to engage in the commerce transaction.

15. A method as recited in claim 1,
wherein the accounts are associated with at least one mobile communication terminal of the subscriber different from the communication terminal used in providing the services, and
wherein said method further comprises receiving from the communication terminal an identifier associated with the at least one mobile communication terminal of the subscriber to identify the one of the accounts for said selecting.

16. A method as recited in claim 15, wherein the communication terminal is a landline telephone.

17. A method as recited in claim 15, wherein the communication terminal is a data terminal.

18. A system for providing services for a subscriber using a communication terminal, comprising:
at least one storage device storing subscriber identity rules based on at least one of date, time, activity, and location; and
at least one real time activity control device selecting in accordance with the subscriber identity rules one of a plurality of accounts associated with the subscriber to record a cost of at least one of a communication session and a commerce transaction.

19. A system as recited in claim 18, wherein said at least one real time activity control device comprises at least one interface to receive signals generated when the communication is initiated using the communication terminal of the subscriber.

20. A system as recited in claim 19, wherein said at least one real time activity control device further comprises a processor to select the one of a plurality of accounts associated with the subscriber based on at least one of date, time, and location of the communication terminal during the communication.

21. A system as recited in claim 20, wherein said at least one interface includes a gateway to receive one of unstructured supplementary service data, a feature request and short message service text, indicating a change in identity requested by the subscriber for subsequent communications.

22. A system as recited in claim 20, wherein said at least one interface includes at least one of a Web server, a handheld application server and an intelligent peripheral/interactive voice response server.

23. A system as recited in claim 22,
wherein the accounts are associated with at least one mobile communication terminal of the subscriber different from the communication terminal used in providing the services, and
wherein said at least one interface receives from the communication terminal an identifier associated with the at least one mobile communication terminal of the subscriber to identify the one of the accounts to be selected by said processor.

24. A system as recited in claim 23, wherein said at least one interface includes the intelligent peripheral/interactive voice response server and the communication terminal is a landline telephone.

25. A system as recited in claim 23, wherein said at least one interface includes the Web server and the communication terminal is a data terminal capable of communicating via the World Wide Web.

26. At least one computer readable medium storing instructions to control a processor when executed to perform a method of providing services for a subscriber using a communication terminal, comprising:
storing subscriber identity rules based on at least activities of a subscriber; and
selecting, in accordance with the subscriber identity rules, one of a plurality of accounts associated with the subscriber to in real-time, authorize, calculate, and record a cost of at least one of a communication session and a commerce transaction.

27. At least one computer readable medium as recited in claim 26, wherein said selecting is performed when the communication is initiated using a terminal of the subscriber.

28. At least one computer readable medium as recited in claim 27,
wherein the communication terminal is mobile and the subscriber identity rules further include at least one of date, time, and location of the communication terminal, and
wherein said selecting is further based on an activity in which the communication terminal is used and at least one of date, time, and location of the communication terminal during the communication session.

29. At least one computer readable medium as recited in claim 27, wherein the accounts include at least one group account of which the subscriber is a member.

30. At least one computer readable medium as recited in claim 29, wherein the subscriber identity rules restrict at least one activity.

31. At least one computer readable medium as recited in claim 30,
wherein the communication terminal is mobile and the subscriber identity rules further include at least one of date, time, and location of the communication terminal, and
wherein said selecting is further based on an activity in which the communication terminal is used and at least one of date, time, and location of the communication terminal during the communication session.

32. At least one computer readable medium as recited in claim 31, wherein said method further comprises selecting a different account permitting the at least one activity, either automatically or in response to a signal from the communication terminal.

33. At least one computer readable medium as recited in claim 29, wherein said method further comprises automatically selecting a different account permitting the at least one activity when the communication terminal is used in the at least one activity.

34. At least one computer readable medium as recited in claim 27, wherein said method further comprises selecting a different account in response to a signal from the communication terminal.

35. At least one computer readable medium as recited in claim 27, wherein said method further comprises automatically selecting a different account when the communication terminal is used in an activity not permitted by the one of the accounts selected initially.

36. At least one computer readable medium as recited in claim 26, wherein said method further comprises selecting a different account in response to a signal from the communication terminal.

37. At least one computer readable medium as recited in claim 26, wherein said method further comprises automatically selecting a different account when the communication terminal is used in an activity not permitted by the one of the accounts selected initially.

38. At least one computer readable medium as recited in claim 26,
wherein the communication terminal is mobile and the subscriber identity rules further include at least one of date, time, and location of the communication terminal, and
wherein said selecting is further based on an activity in which the communication terminal is used and at least one of date, time, and location of the communication terminal during the communication session.

39. At least one computer readable medium as recited in claim 26, wherein the communication terminal is a mobile communication terminal used to engage in the commerce transaction.

40. At least one computer readable medium as recited in claim 26,
wherein the accounts are associated with at least one mobile communication terminal of the subscriber different from the communication terminal used in providing the services, and
wherein said method further comprises receiving from the communication terminal an identifier associated with the at least one mobile communication terminal of the subscriber to identify the one of the accounts for said selecting.

41. A method as recited in claim 40, wherein the communication terminal is a landline telephone.

42. A method as recited in claim 40, wherein the communication terminal is a data terminal.
